(19) United States
(12) Patent Application Publication
(10) Pub. No.: US 2017/0146084 A1
(43) Pub. Date: May 25, 2017

(54) Braking System

(71) Applicant: SAF-HOLLAND GmbH, Bessenbach (DE)

(72) Inventors: Olaf Drewes, Aschaffenburg (DE); Oliver Marschner, Haibach (DE)

(73) Assignee: SAF-HOLLAND GmbH, Bessenbach (DE)

(21) Appl. No.: 15/320,848

(22) PCT Filed: Jun. 16, 2015
(86) PCT No.: PCT/EP2015/063410

§ 371 Date: Dec. 21, 2016

(30) Foreign Application Priority Data
Jul. 1, 2014 (DE) 10 2014 212 673.8

(51) Int. Cl. F16D 66/02; F16D 51/20

(52) U.S. Cl. CPC F16D 66/02; F16D 51/20

(57) ABSTRACT

The invention relates to a brake system in particular for wedge-actuated drum brakes, comprising a carrier unit, an actuation unit, a reference unit and an indicator unit, wherein the reference unit shields the carrier unit and the actuation unit at least in regions, wherein the actuation unit engages on the carrier unit and displaces the carrier unit into a particular position relative to the reference unit or secures the carrier unit in one position relative to the reference unit, wherein the carrier unit engages on the indicator unit in order to displace the indicator unit into a particular position relative to the reference unit, wherein a state of wear of the brake system can be determined from outside the brake system by way of the position of the indicator unit relative to a reference geometry provided on the reference unit.

### BACKGROUND OF THE INVENTION

The present invention relates to a brake system, in particular a wedge-actuated drum brake for use in utility vehicles.

The brake systems known from the prior art are generally subject to usage-dependent wear, wherein, when the wear limit is reached, the braking action of the brake is diminished and is no longer ensured, and thus the driving safety of the utility vehicle can no longer be ensured. To be able to ensure the required safety, it has proven expedient here to provide wear displays or wear indicators on a brake system, by way of which the state of wear of the brake can be identified. In particular in the case of drum brakes, in which the wearing parts are arranged within the brake drum and are thus not visible to a user from the outside, it has hitherto been necessary here to resort to electrical wear indicators, which are for example integrated into the friction lining of the brake shoe and which, via a line system, transmit the state of wear of the brake by way of electrical signals to the workstation of the user or to the driver of the vehicle. Said electrical wear indicators are firstly cumbersome in terms of their manufacture and are secondly susceptible to faults, and are always reliant on the correct functioning of the electrical system of the utility vehicle. There is therefore a demand for improving the brake system with regard to simplifying the wear indicator and increasing the reliability of the indicator system.

It is correspondingly an object of the present invention to provide a brake system which is simple to produce and which permits reliable indication or display of the wear of the brake system to a user.

### SUMMARY OF THE INVENTION

According to the invention, the brake system comprises a carrier unit, an actuation unit, a reference unit and an indicator unit, wherein the reference unit shields the carrier unit and the actuation unit at least in regions, wherein the actuation unit engages on the carrier unit and displaces the carrier unit into a particular position relative to the reference unit or secures the carrier unit in one position relative to the reference unit, wherein the carrier unit engages on the indicator unit in order to displace the indicator unit into a particular position relative to the reference unit, wherein a state of wear of the brake system can be determined from outside the brake system by way of the position of the indicator unit relative to a reference geometry provided on the reference unit. The brake system is particularly preferably a drum brake, in particular for use in a utility vehicle. The drum brake is particularly preferably in the form of a wedge-actuated drum brake, because, at present, a simple indicator system for wear indication is not yet known from the prior art for such wedge-actuated drum brakes. The system according to the invention for indicating the wear makes it possible even in the case of wedge-actuated drum brakes to determine the state of wear of the brake without the use of complex electrical indicator systems which are susceptible to faults. The reference unit is preferably a covering plate of the drum brake and, in particular, preferably shields the interior of the drum brake with respect to environmental influences. The carrier unit, a section of the actuation unit and an indicator unit are preferably situated in the interior of the brake system. The actuation unit is in this case preferably the actuation system of a drum brake which exerts a force on the brake shoes of the drum brake such that said brake shoes move apart from one another at least at one of the two sides thereof in order to be pressed against the brake drum from the inside. In this context, the actuation unit is preferably in the form of a wedge unit. It is furthermore preferable for the actuation unit to comprise a readjustment device which, with increasing wear of the brake shoes, shifts the zero position or the rest position of the actuation unit, and the brake shoes, outward in accordance with the wear, such that the same braking action can be realized by way of the brake system at all times at least over the intended service life of the brake shoes. In this context, the readjustment device preferably compensates the wear-induced thickness loss of the brake shoes and of the brake drums and ensures that, even with progressive wear of the brake shoes or brake drums, only in each case approximately the same actuation travel must be covered by the actuation unit before the brake shoes bear against the brake drum and thus a braking action is realized. The carrier unit is preferably a section on one of the moving parts of the brake system, preferably on the brake shoe, or of the force-transmitting element, which engages on the brake shoe, of the actuation unit, or of the moving part of the readjustment device. Here, the carrier unit is particularly preferably designed for engaging on the indicator unit such that the indicator unit is displaced relative to the reference unit in accordance with the movement of the carrier unit relative to the reference unit. Here, the indicator unit is preferably of single-part or multi-part form, wherein the position of an element of the indicator unit relative to the reference unit is adjustable in conjunction with the movement of the carrier unit. On the reference unit there is provided a reference geometry which makes it possible in a particularly simple manner for a user of the brake system to determine the position of the indicator unit relative to the reference unit and, from said position, infer a particular state of wear of the brake system. Here, a particular advantage of the present invention has proven to be that the position of the indicator unit relative to the reference geometry of the reference unit can be determined by a user either visually or haptically, that is to say by touch or feel, even in the assembled state of the brake system. The brake system according to the present invention is in this case characterized in particular by the fact that the state of wear of the brake shoes of the brake system can be determined simply by identifying the position of the indicator unit relative to the reference geometry, without further electrical displays or inspection systems.

In a preferred embodiment, the indicator unit can be fixed at least in sections to the carrier unit. The indicator unit is in this case particularly preferably an element such as for example a bolt which, by way of a corresponding engagement geometry, can be fixed in positively locking and/or non-positively locking fashion to the carrier unit. The indicator unit is in this case particularly preferably fixed to the carrier unit. It may furthermore be preferable for the indicator unit to be fixed cohesively to the carrier unit, for example by way of a welding process. As a result of the fixing of the indicator unit to the carrier unit, the exact position of the carrier unit relative to the reference geometry can be identified at all times by way of the indicator unit fixed to the carrier unit. In other words, the indicator unit does not move relative to the carrier unit.

It is furthermore preferable for the indicator unit to be guided at least in sections on the reference unit and to be secured against displacement transversely with respect to an indicator path. In addition or alternatively to the fixing of the indicator unit to the carrier unit, the indicator unit may also be guided on the reference unit. Here, it is merely necessary for the indicator unit to remain displaceable relative to the reference unit along an indicator path, because the position of the indicator unit on the indicator path relative to the reference unit must be variable in order to be able to indicate a particular state of wear of the brake system. The indicator path may in this case preferably be of straight or else slightly curved form. A straight form of the indicator path has the advantage that it is easy to produce. A curved indicator path advantageously follows the displacement movement of the carrier unit, which is preferably provided on the brake shoe, and thus permits exact determination of the position of the carrier unit, and thus an exact indication of the state of wear, with sliding friction being avoided. The indicator unit is preferably guided in a cutout of elongate form of the reference unit, which cutout extends substantially along the indicator path. In a particularly preferred embodiment, the indicator unit is guided on the reference unit and, here, is not fixed to the carrier unit. In this embodiment, when the brake system is actuated, the carrier unit abuts only against the indicator unit in order to displace the latter along the indicator path and move said indicator unit into a position relative to the reference unit which indicates a certain state of wear of the brake system. The indicator unit advantageously maintains the position of maximum deflection on the reference geometry even if the carrier unit has already been displaced backward by an actuation travel after the end of the actuation process of the brake system. It is advantageously possible for the state of maximum deflection to be read off as an indicator for the state of wear of the brake system even when the brake is not actuated.

It is furthermore preferable for the indicator unit to be displaceable in substantially translational fashion along the indicator path. Here, “substantially translational” means that relatively small deviations from the pure path movement without rotational components, which deviations do not exceed 10 percent of the main path movement, are possible within the scope of the invention. Here, the indicator path runs in the direction in which the carrier unit moves relative to the reference unit. In this way, it is possible to avoid cumbersome constructions with rotary axles and lever elements, so as not only to save weight but also keep the construction as simple as possible. It is advantageously possible to avoid transformations of movement directions, which give rise to increased susceptibility to faults and are liable to a relatively high level of wear of the components that are moved relative to one another.

In a further preferred embodiment, the indicator unit has an indicator element whose position relative to the reference geometry can be haptically and/or visually identified by a user. The indicator element is in this case preferably a section of the indicator element, or of one of several elements of the indicator unit, which is in particular designed for assuming a certain position relative to the reference geometry and making it possible for a user to easily determine said position. It is particularly preferable here for the indicator element to be of bolt-like form and project through the reference geometry, wherein, in this way, the position of the indicator element can be easily determined by a user by touching the indicator element. The indicator unit is in this case particularly preferably of two-part form, wherein a first element of the indicator unit is provided for being fixed to the carrier unit and for transmitting a movement or displacement of the carrier unit to the indicator element of the carrier unit, wherein the indicator element of the carrier unit is preferably secured or guided on the reference unit, wherein the position of the indicator element can be easily determined by a user from outside the brake system, for example by touch.

In a particularly preferred embodiment, the indicator element has an immobilizing function which secures the indicator element in its position of maximum deflection relative to the reference unit. It is self-evident that, during operation of the brake system, the carrier unit together with the brake shoes and the movable sections of the actuation unit cover an operating travel, that is to say the travelling distance by which the brake shoes are displaced relative to the brake drum before a braking action is realized. At the end of the braking process, said operating travel is covered by the carrier unit or the corresponding elements of the brake system in the opposite direction again. It may however be preferable for the indicator element to be designed to indicate the relative position of the carrier unit relative to the reference geometry in the state in which the brake system imparts the full braking action, that is to say the brake shoes are pressed against the drum brake to the maximum extent. The indicator element preferably has, for this purpose, an engagement geometry for a setting element of the indicator unit, which setting element is fixed to the carrier unit, wherein the setting element displaces the indicator element firstly into a position of maximum deflection and, when the brake is released, covers the corresponding operating travel in the opposite direction without displacing the indicator element relative to the reference unit at the same time. It is advantageously possible for the indicator element to remain stationary in its position of maximum deflection. The indicator element particularly preferably has an immobilizing function which secures the indicator element so as to prevent it from being displaced backward relative to the reference unit when the brake is released. The immobilizing function may in this case particularly preferably be ensured by way of a plastically deformable section of the indicator unit. Alternatively or in addition, the indicator unit may also engage by way of an engagement geometry, which is for example in the form of a toothing, on a corresponding geometry of the reference unit or the reference geometry. It is advantageously possible, by way of a certain minimum force, for the indicator unit to be displaced relative to the reference unit, with the positive locking and/or non-positively locking forces between engagement geometry and reference unit being overcome. In other words, the immobilizing function makes it possible, during periodic operation of the brake system, for in each case the maximum travel or the position of maximum deflection of the brake shoes relative to the reference geometry to be determined. The further deflected said position of the brake shoes is, the greater, normally, is the wear that has already occurred in the brake system.

The immobilizing function is particularly preferably realized by way of an engagement element of the indicator element, which engagement element engages in positively locking and/or non-positively locking fashion into a detent geometry of the reference unit. It is particularly preferable for a detent geometry, which is for example in the form of a toothing, to be formed on the reference unit. Here, the indicator element preferably has an engagement element which engages in positively locking and/or non-positively locking fashion into the detent geometry of the reference unit.

In a preferred embodiment, the indicator element projects in regions from the carrier unit, wherein the reference geometry is in the form of a cutout through which the indicator element is visible and/or touchable and/or through which the indicator element projects. Particularly preferably in the case in which the indicator element is fixed in positively locking and/or cohesive fashion to the carrier unit, it is preferable for said indicator element to extend away from the carrier unit, or in other words to project therefrom.

It is furthermore preferable here for the reference geometry to be in the form of a cutout, preferably an elongate cutout, or a circular cutout in the reference unit. In particular, if the reference geometry is arranged on the inwardly facing side on the running gear of the utility vehicle and is thus not readily visible to a user of the brake system from the outside, it is preferable if the position of the indicator element relative to the reference geometry can be touched by a user. Here, it is particularly preferably possible for the reference geometry to have a projection which indicates, for example, the presence of a critical state of wear when the indicator element is arranged adjacent to the reference geometry or to the projection of the reference geometry. In this way, it is possible for the state of wear of the brake system to be read off by a user with a high level of certainty.

The indicator element preferably extends substantially transversely with respect to a pivoting or displacement direction of the carrier unit. The indicator unit particularly preferably has a main direction of extent, that is to say a direction along which the extent of the indicator element is greater than in the other spatial directions. Said main direction of extent of the indicator element particularly preferably extends transversely, and in particular preferably perpendicularly, with respect to a pivoting or displacement direction of the carrier unit. Here, as the pivoting or displacement direction of the carrier unit, it is the case here in particular that the path described by the displacement of the brake shoes during the braking process is used for defining said geometrical value. It is thus particularly preferably the case that the indicator element extends substantially transversely with respect to a plane which is spanned by the displacement movement of the brake shoes or of the moving parts of the actuation unit. It is thus advantageously the case that the indicator element projects substantially transversely with respect to the pivoting direction or transversely with respect to the displacement direction of the carrier unit, particularly preferably of the brake shoes, from said carrier unit, and it is easily possible from outside the brake system to determine the displacement movement of the carrier unit, and particular positions of the carrier unit relative to the reference geometry, by way of the indicator element.

The indicator element is particularly preferably in the form of a bolt and arranged in a distal end region of the carrier unit. The indicator element is particularly preferably a bolt which is fixed to the carrier unit and which, aside from indicating the position of the carrier unit relative to the reference unit, also performs further functions, such as for example the support of the brake shoes relative to a readjustment and/or restoring device of the brake system. As a result of various tasks being performed in this way by an indicator element in the form of a bolt, it is possible in particular for the weight of the brake system to be considerably reduced, because a large range of functions in the brake system can be realized with a small number of components. The distal end region of the carrier unit is preferably that region of a carrier unit in the form of a brake shoe in which said carrier unit interacts with the actuation unit.

In a particularly preferred embodiment, the reference geometry is in the form of a cutout through which a user can insert a finger, wherein the indicator unit is arranged on the carrier unit such that a state of the brake system in which the maximum wear has not yet been reached is distinguished by the fact that the user can touch and/or see the indicator unit through the reference geometry. In a particularly simple embodiment of the brake system, the reference geometry is in the form of a simple, preferably circular cutout which is formed into the reference unit in the form of a metal plate or covering plate. The indicator unit is preferably arranged on the carrier unit such that the state in which no wear has occurred in the brake system is manifest in a position of the indicator unit relative to the reference unit, or relative to the reference geometry, in which the indicator unit is arranged exactly centrally or entirely below the reference geometry. With increasing wear of the brake system, it is the case here that the position of the indicator unit together with the position of the carrier unit relative to the reference unit is displaced such that the maximum admissible wear of the brake system is distinguished by the fact that a user of the brake system can still touch and/or see the indicator unit through the reference geometry in the form of a cutout. For the user, it is thus easily possible to identify that, in the foreseeable future, the maximum admissible wear of the brake system will be exceeded, and a change of the brake shoes of the brake system must be performed. The advantage of this embodiment is that the reference geometry can be of particularly small form and can be closed off in a simple manner for example by way of a plug in order, during normal operation of the brake system, to prevent dirt and contaminants from being able to pass into the interior of the brake system. Furthermore, the embodiment of the indicator unit is particularly simple, because it needs merely to have a characteristic projection or a corresponding characteristic geometry which is arranged on the carrier unit such that, with increasing wear, said projection geometry is displaced out of the region accessible through the reference geometry.

In a preferred embodiment, the carrier unit is provided on a displaceable section of the actuation unit, wherein the carrier unit is preferably an outer surface of a readjustment device of the actuation unit. With this preferred embodiment, it can be achieved that the indicator unit can, independently of the brake shoes of the brake system, be placed into the corresponding position, which indicates a particular state of wear, relative to the reference unit. This is advantageous in particular because the brake shoes are generally subjected to a relatively high temperature loading, which preferably should not be transmitted to the indicator unit in order that injury to the user when touching the indicator unit to identify the position thereof is avoided. Furthermore, it is thus possible, by way of simple modification of the actuation unit, for the brake system with an indicator device to be integrated within the meaning of the invention even into existing drum brake systems, without the need for the brake shoes, which are manufactured in high unit quantities, to be modified for this purpose.

The carrier unit is alternatively preferably provided on a brake shoe of the brake system, wherein the carrier unit is preferably a bearing lug on the brake shoe. The fixing of the indicator unit to the brake shoe of the brake system may be preferable because corresponding engagement geometries are normally already provided on the brake shoe, and therefore only minor modifications to the brake system are necessary. In particular, in order to ensure a restoring function of the brake shoes, a bearing lug is preferably already provided on a distal end of the brake shoe, into which bearing lug an indicator element, for example in the form of a bolt, can be inserted and can be fixed, preferably is fixed, to said bearing lug.

Further advantages and features of the present invention will emerge from the following description with reference to the appended figures. Here, it is possible for individual features of individual embodiments to also be used in other embodiments unless this is explicitly ruled out or does not appear to be technically expedient. In the figures:

### BRIEF DESCRIPTION OF THE DRAWINGS

FIGS. 1a and 1b show two views of a preferred embodiment of the brake system according to the invention;

FIGS. 2a and 2b show two views of a further preferred embodiment of the brake system according to the invention;

FIGS. 3a and 3b show two views of a further preferred embodiment of the brake system according to the invention;

FIG. 4 shows a further partially sectional view of a preferred embodiment of the brake system according to the invention; and

FIGS. 5a and 5b show two further views of a preferred embodiment of the brake system according to the invention.

### DETAILED DESCRIPTION OF THE PREFERRED EMBODIMENTS

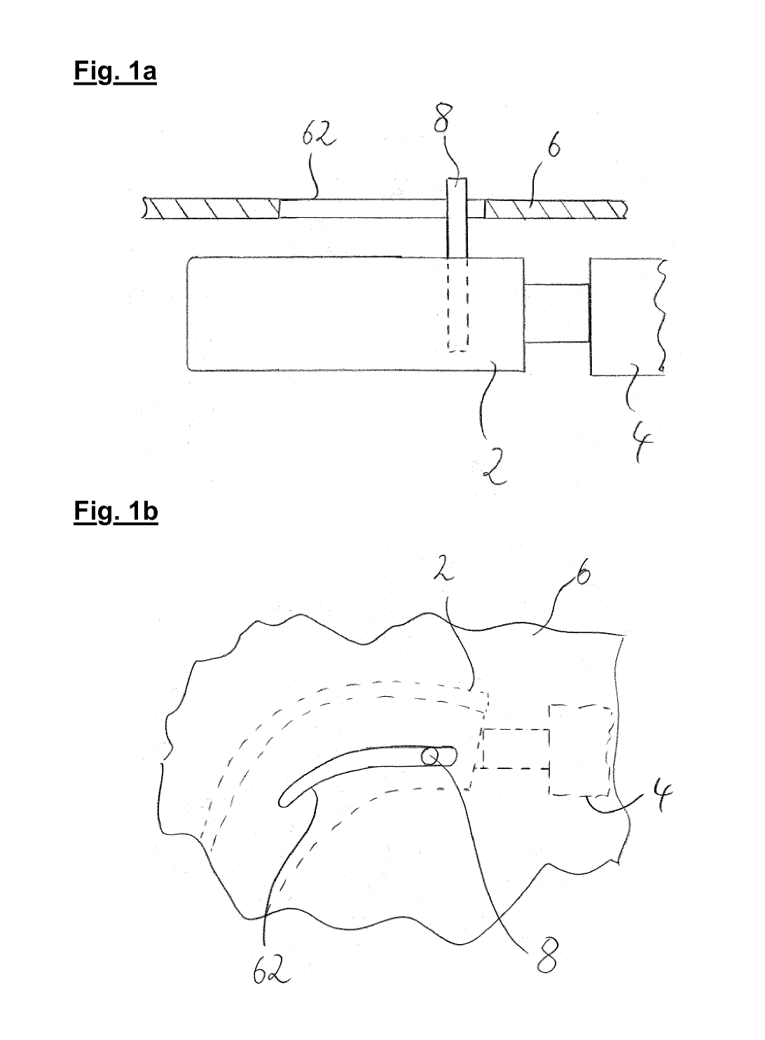

FIG. 1a shows, schematically and in greatly simplified form, the major components of the brake system according to the invention. Here, a carrier unit 2 is provided to which an indicator unit 8 is preferably fixed. Furthermore, an actuation unit 4 is provided which transmits a force to the carrier unit 2, which is preferably in the form of a brake shoe, in order to displace said carrier unit in the leftward direction in relation to the arrangement in the figure. Arranged above the carrier unit 2 and actuation unit 4 is a reference unit 6 which at least regionally covers or shields the carrier unit 2 and the actuation unit 4. In a particularly preferred embodiment, the reference unit 6 shields carrier unit 2 and actuation unit 4 completely in one direction, that is to say in the present example with respect to environmental influences from above. The reference unit 6 has a reference geometry 62 through which the indicator unit 8 advantageously projects at least in regions. In this embodiment, the user of the brake system can, from that side of the brake system which is shown as the top side in the figure, identify the exact position of the indicator unit 8 relative to the reference geometry 62 and thereby infer a position of the carrier unit 2 relative to the reference unit 6. A particular position of the carrier unit 2 which, in the present case, is preferably a brake shoe of the brake system, relative to the reference unit 6 is in this case indicative in particular of the presence of a particular state of wear of the brake linings of the brake shoe.

FIG. 1b shows the embodiment illustrated in FIG. 1a from the side from which a user of the brake system can access the brake system. Here, the actuation unit 4 and the carrier unit 2 are, for the most part, concealed by the reference unit 6. The reference geometry 62 is advantageously in the form of an elongate cutout in the reference unit 6. The indicator unit 8 can in this case be touched and/or seen by a user of the brake system, wherein the position of said indicator unit relative to the reference geometry 62 of elongate form is indicative of a particular state of wear.

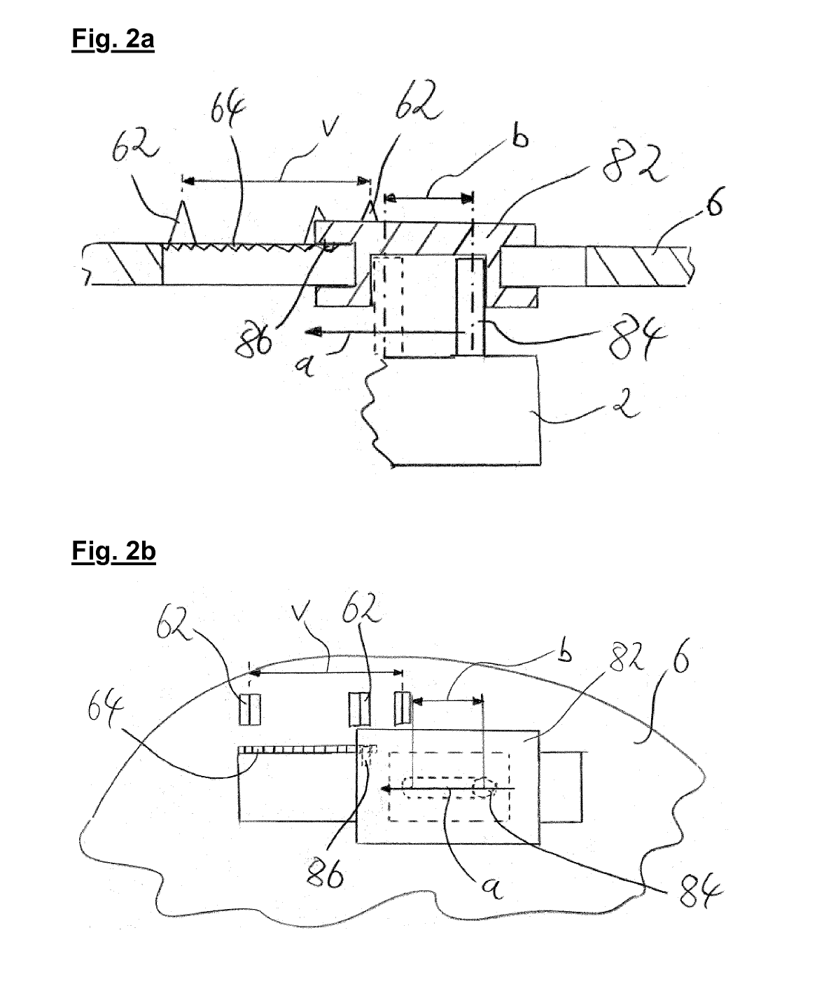

FIG. 2a shows a further preferred embodiment of the brake system according to the invention. Here, the indicator unit 8 has a setting element 84 which is fixed to the carrier unit 2. Furthermore, the indicator unit 8 has an indicator element 82 which is advantageously guided on the reference unit 6 and which can assume a particular position relative to the reference geometry 62. As illustrated in the figure, the setting element 84 has a movement clearance relative to the indicator element 82, wherein said movement clearance serves as compensation for the operating travel b of the brake system. The operating travel b is preferably the travel by which the brake shoe is displaced, and is displaced backward again, relative to the reference unit 6 during a braking process and a brake release process. On the reference unit 6 there is preferably provided a detent geometry 64 which is designed for entering into positive locking engagement with a corresponding engagement geometry 86 of the indicator element 82, wherein only a relatively low force is necessary to overcome the positively locking engagement between detent geometry 64 and engagement geometry 86, and the indicator element 82 is, by way of the setting element 84, displaceable relative to the reference unit 6 along the indicator path a or parallel to the indicator path a. The advantage of this embodiment is that, even after the relaxation or release of the brake, the indicator element 82 still indicates the state of maximum deflection of the carrier unit 2. Furthermore, the reference geometry 62 is advantageously in the form of a projection or a multiplicity of projections which characterize a wear travel v along which the indicator element 82 can be displaced relative to the reference unit 6. That projection of the reference geometry 62 which is shown on the right in FIG. 2a indicates, in accordance with the position of that edge of the indicator element 82 which is shown on the left in the figure, the state of minimum wear. When the indicator element 82 has been displaced to the level of the projection, shown on the left in the figure, the reference geometry 62, the maximum state of wear of the brake system is thereby indicated.

FIG. 2b shows the embodiment shown in FIG. 2a, likewise again from the perspective of the user of the brake system, wherein the same features of the brake system have been denoted by the same reference designations.

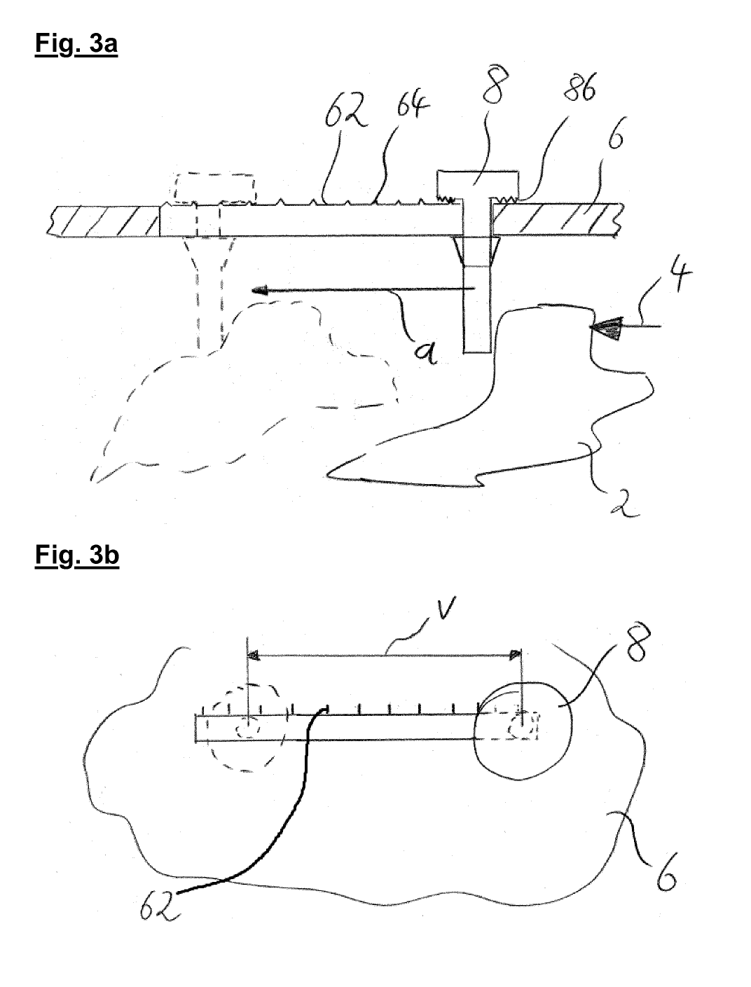

FIG. 3a shows an embodiment of the brake system according to the invention in which the indicator unit 8 is not fixed to the carrier unit 2 but rather is merely displaced by the carrier unit 2 along an indicator path a. The indicator unit 8 is in this case preferably guided on the reference unit 6, wherein a displacement of the indicator unit 8 relative to the reference unit 6 transversely with respect to the indicator path a is not possible. The advantage of this embodiment is that the indicator unit 8 can be of much simpler design, wherein the preferably bolt-like indicator element 82 has a corresponding clip mechanism by way of which the indicator unit 8 can be easily pressed into the reference geometry 62, in the form of a cutout, of the reference unit 6 and is subsequently displaced, during operation of the drum brake, by the carrier unit 2, wherein the respective position of indicator unit 8 relative to reference unit 6 is indicative of a particular state of wear. In turn, the reference unit 6 preferably has a detent geometry 64, and the indicator unit 8 has a corresponding engagement geometry 86 for holding the indicator element 82, after release of the brake, in the position assumed by said indicator element under the action of the carrier unit 2 in the position of maximum deflection thereof.

FIG. 3b shows the embodiment of the brake system according to the invention illustrated in FIG. 3a from the view of the user, wherein the wear travel v is denoted analogously to the embodiment of FIGS. 2a and 2b.

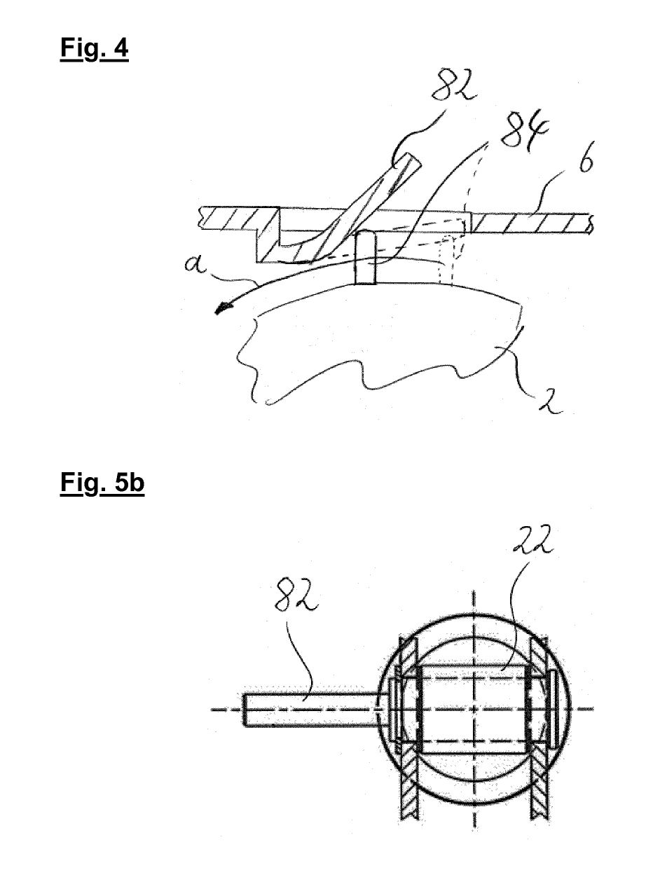

FIG. 4 shows a further preferred embodiment of the brake system according to the invention, wherein the indicator element 82 has an immobilizing function which is ensured by way of a plastically deformable section of the indicator element 82. Here, the indicator element 8 is of two-part form and has, firstly, a setting element 84 which is fixed to the carrier unit 2 and, secondly, an indicator element 82 which is in the form of an element projecting from the reference unit 6. With every displacement of the carrier unit 2 along the indicator path a relative to the carrier unit MULE, the setting element 84 is also displaced further, and pushes the indicator element 82, which is plastically deformable at least in sections, upward. Aside from a spring-back action caused by a deformation, which is to a certain extent elastic, of the indicator element 82, said indicator element in this case remains in each case in the position of maximum deflection, and thus indicates the position of the carrier unit 2 in the presence of maximum braking force even after the break has been released. The maximum admissible state of wear of the brake system may in this case be distinguished by the fact that the indicator element 82 projects beyond the reference unit 6, as illustrated in the figure.

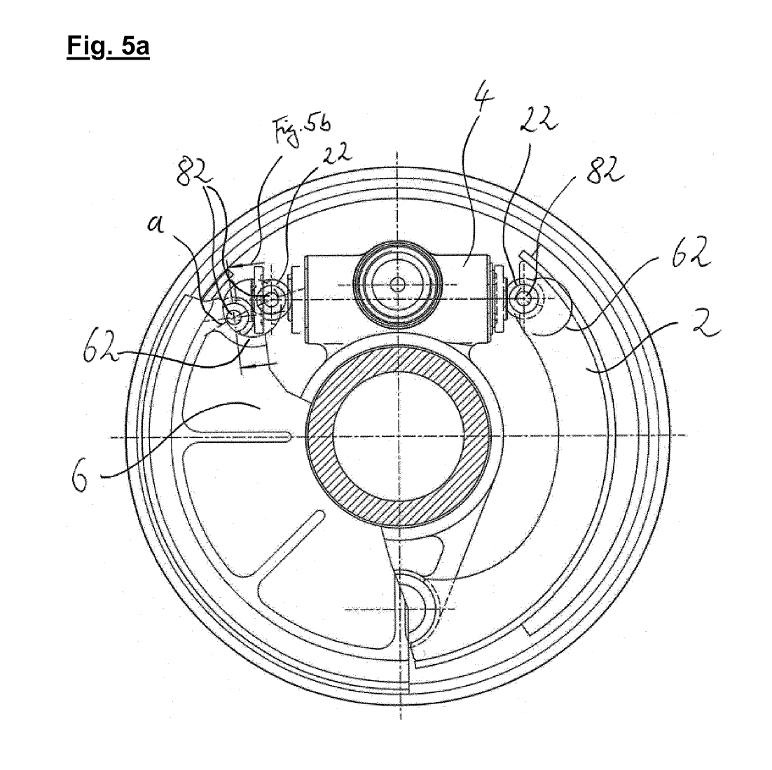

FIGS. 5a and 5b show two partially sectional views of a preferred embodiment of the preferred brake system. Here, it is illustrated merely schematically that the actuation unit 4 and two carrier units 2 provided on the brake system are for the most part concealed by a reference unit 6. The reference unit 6 has one, preferably two, reference geometry (geometries) 62 formed as (a) simple circular cutout(s), through which the engagement region between carrier unit 2 and actuation unit 4 can be touched or seen by a user of the brake system. The setting unit 8 preferably has an indicator element 82 in the form of a bolt which is inserted into the distal end region 22, in the form of a bearing region, of the carrier unit 2 and is fixed thereto. In the moment at which the brake linings arranged on the brake system or on the carrier unit 2 formed as a brake shoe have reached their maximum admissible wear, the indicator unit 82 is thus situated at the left-hand side of the reference geometry 62.

The sectional view illustrated in FIG. 5b in the section plane denoted in FIG. 5a illustrates that the indicator element 82 projects from the carrier unit 2, transversely with respect to the pivoting direction or displacement direction of the carrier unit 2, and is preferably in the form of a cylindrical bolt.

### LIST OF REFERENCE DESIGNATIONS:

2—Carrier unit
4—Actuation unit
6—Reference unit
8—Indicator unit
22—Distal end region
62—Reference geometry
64—Detent geometry
82—Indicator element
84—Setting element
86—Engagement geometry
a—Indicator path
b'Actuation travel
v—Wear travel

1.-11. (canceled)

12. A brake system, comprising:
a carrier unit;
an actuation unit;
a reference unit; and
an indicator unit;
wherein the reference unit shields the carrier unit and the actuation unit at least in regions;
wherein the actuation unit at least one of engages on the carrier unit and displaces the carrier unit into a particular position relative to the reference unit, and secures the carrier unit in one position relative to the reference unit;
wherein the carrier unit is configured to engage the indicator unit to displace the indicator unit into a particular position relative to the reference unit;
wherein a state of wear of the brake system can be determined from outside the brake system by way of the position of the indicator unit relative to a reference geometry provided on the reference unit; and
wherein the indicator unit is configured to be guided at least in sections on the reference unit and is secured against displacement transversely with respect to an indicator path.

13. The brake system as claimed in claim 12, wherein the indicator unit is configured to be fixed at least in sections to the carrier unit.

14. The brake system as claimed in claim 13, wherein the indicator unit includes an indicator element, and wherein the position of the indicator element relative to the reference geometry can be at least one haptically and visually identified by a user.

15. The brake system as claimed in claim 14, wherein the indicator element includes an immobilizing arrangement which secures the indicator element in a position of maximum deflection relative to the reference unit.

16. The brake system as claimed in claim 15, wherein the immobilizing arrangement includes an engagement element of the indicator element, and wherein the engagement element engages in at least one of a positively locking manner and non-positively locking manner into a detent geometry of the reference unit.

17. The brake system as claimed in claim 16, wherein the indicator element projects in regions from the carrier unit, and wherein the reference geometry includes a cutout through which the indicator element is at least one of visible, one of touchable, and through which the indicator element projects.

18. The brake system as claimed in claim 17, wherein the indicator element extends substantially transversely with respect to a pivoting or displacement direction of the carrier unit.

19. The brake system as claimed in claim 18, wherein the indicator element includes a bolt and is arranged in a distal end region of the carrier unit.

20. The brake system as claimed in claim 19, wherein the reference geometry includes a cutout through which a user can insert a finger, and wherein the indicator unit is arranged on the carrier unit such that a state of the brake system in which the maximum wear has not yet been reached is distinguished by the fact that the user can touch and/or see the indicator unit through the reference geometry.

21. The brake system as claimed in claim 20, wherein the indicator unit is displaceable in substantially translational fashion along the indicator path.

22. The brake system as claimed in claim 12, wherein the indicator unit includes an indicator element, and wherein the position of the indicator element relative to the reference geometry can be at least one haptically and visually identified by a user.

23. The brake system as claimed in claim 22, wherein the indicator element includes an immobilizing arrangement which secures the indicator element in a position of maximum deflection relative to the reference unit.

24. The brake system as claimed in claim 23, wherein the immobilizing arrangement includes an engagement element of the indicator element, and wherein the engagement element engages in at least one of a positively locking manner and non-positively locking manner into a detent geometry of the reference unit.

25. The brake system as claimed in claim 22, wherein the indicator element projects in regions from the carrier unit, and wherein the reference geometry includes a cutout through which the indicator element is at least one of visible, one of touchable, and through which the indicator element projects.

26. The brake system as claimed in claim 22, wherein the indicator element extends substantially transversely with respect to a pivoting or displacement direction of the carrier unit.

27. The brake system as claimed in claim 22, wherein the indicator element includes a bolt and is arranged in a distal end region of the carrier unit.

28. The brake system as claimed in claim 12, wherein the reference geometry includes a cutout through which a user can insert a finger, and wherein the indicator unit is arranged on the carrier unit such that a state of the brake system in which the maximum wear has not yet been reached is distinguished by the fact that the user can touch and/or see the indicator unit through the reference geometry.

29. The brake system as claimed in claim 12, wherein the indicator unit is displaceable in substantially translational fashion along the indicator path.
